(19) United States
(12) Patent Application Publication
(10) Pub. No.: US 2007/0288638 A1
(43) Pub. Date: Dec. 13, 2007

(54) METHODS AND DISTRIBUTED SYSTEMS FOR DATA LOCATION AND DELIVERY

(75) Inventors: Son T. Vuong, Vancouver (CA); Xin Liu, Bellevue, WA (US); Jun Wang, Richmond (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: British Columbia, University of, Vancouver (CA)

(21) Appl. No.: 11/695,592

(22) Filed: Apr. 2, 2007

Related U.S. Application Data
(60) Provisional application No. 60/788,046, filed on Apr. 3, 2006.

(51) Int. Cl. G06F 15/173

(52) U.S. Cl. 709/226

(57) ABSTRACT

A category overlay infrastructure for Peer-to-Peer (P2P) content search and a cost-effective large-scale on-demand media streaming are described. Based on a novel hierarchical P2P model, the category overlay infrastructure can provide good load balancing and efficient keyword search services for large-scale networks. The category overlay search services may be applied for locating video segments. The on-demand media streaming architecture can apply an efficient media segment scheduling algorithm and aggregate concurrent media streaming from multiple sources to allow users to play high-quality video or other media.

### REFERENCE TO RELATED APPLICATION

This application claims the benefit under 35 U.S.C. §119 of U.S. patent application No. 60/788,046 filed on 3 Apr. 2006 and entitled PEER-TO-PEER INFRASTRUCTURE AND SYSTEM FOR LARGE-SCALE CONTENT SEARCH AND COST-EFFECTIVE ON-DEMAND MEDIA STREAMING which is hereby incorporated herein by reference as though fully set out herein.

### TECHNICAL FIELD

This invention relates to the delivery of data by way of data communication networks. Embodiments of the invention provide systems and methods for streaming media data such as audio and/or video data.

### BACKGROUND

There is an increasing demand for practical systems capable of delivering digital media to consumers. Delivering digital video and other media by way of a computer network such as the internet involves transmitting large amounts of data over the network.

Some on-demand media delivery systems have a Client/Server architecture in which consumers, also known as clients, request and receive media files from a single server computer or a small number of server computers. The media is hosted on the server computer. Consumers can request that the server deliver media to their computers over the network. In some cases, consumers download media files to local data stores and can subsequently play the media. Other cases stream media files. Streaming delivers media files in such a way that part of a file can be played back by the consumer while another part of the file is simultaneously being transmitted.

A problem with server-based methods is that they are not readily scalable to serve a large number of consumers. As the number of client requests for media increases, as server of any given capacity will eventually fail to respond to requests in a timely manner, and will become the bottleneck in the flow of media files to clients.

Numerous methods have been devised and are know in the art to alleviate this strain on a server's capacity. These include:
Multicasting—in which the same stream of data is simultaneously delivered to multiple clients.
Batching—in which multiple client requests are aggregated into one multicast session. Batching is described, for example, in G. O. Young, C. C. Aggarwal, J. L. Wolf and P. S. Yu, On Optimal Batching Policies for Video-on-Demand Storage Servers, Proc. of ICMCS '96, Pittsburgh, Pa., 1996.
Patching—which allows a client to catch up with an on-going multicast session and patch the missing starting portion through server unicast. Patching is described, for example, in K. A. Hua, Y. Cai and S. Sheu, Patching: A Multicast Technique for True On-Demand Services, Proc. of ACM Multimedia '98, Bristol, England, 1998.
Merging—in which a client can repeatedly merge into a larger and larger multicast session. Merging is described, for example, in D. Eager, M. Vernon and J. Zahorjan, Minimizing Bandwidth Requirements for On-Demand Data Delivery, IEEE Transactions on Knowledge and Data Engineering 13(5), 2001.
Periodic broadcasting—in which the server separates a media file into segments and periodically broadcasts the segments through different multicast channels. A client can choose a channel to join. Periodic Broadcasting is described, for example, in S. Viswanathan and T. Imielinski, Metropolitan Area Video-on-Demand Service using Pyramid Broadcasting, Multimedia Systems 4, 1996.
Cooperative proxy caching techniques including prefix-based caching as described in S. Sen, J. Rexford, and D. Towsley, Proxy Prefix Caching for Multimedia Streams, in Proc. of INPOCOM'99. When video is streamed to clients using the prefix-based caching method, proxies store the initial video frames of popular videos. Upon receiving a request for a video file, a proxy initiates transmission of the initial frames of the video file to the requesting client and simultaneously requests the remaining frames of the video file from a server computer. This method allows the client to begin viewing the video sooner than if the entire file were transmitted from the server.
Segment-based caching as described in S. Acharya and B. Smith, MiddleMan: A Video Caching Proxy Server, in Proc. of NOSSDAV '00, 2000 and Y. Chae, K. Guo, M. Buddhikot, S. Suri and E. Zegura, Silo, Tokens, and Rain-bow: Schemes for Fault Tolerant Stream Caching, Special Issue of IEEE JSAC on Internet Proxy Services, 2002. In the segment-based caching method, parts of a media file are cached on different proxies in the network and the video file stream is transmitted to the requesting client in a coordinated manner from the proxies.

Peer-to-peer (P2P) software permits computers on a network to exchange data. Each computer running P2P software may be called a peer, A number of computers running P2P software can form a network. Each peer may share data that it has in a data store with other peers in the network and may request and receive data from other network peers. Typically, peers can join and leave a P2P network dynamically. For instance a peer may leave a P2P network when the P2P program, the peer computer, or the peer computer's connection to the internet is disabled, either by the user or due to a failure of the program, computer or connection. The size of a P2P network can fluctuate continuously. Some examples of P2P computer programs are Gnutella™, Napster™, Kazaa™ and BitTorrent™.

There remains a need for practical and cost effective systems and methods for distributing media (including for example video and audio) as well as other data. There is a particular need for practical and cost effective systems and methods for distributing streaming media.

Any system which permits data to be retrieved from a range of locations must provide some system for identifying the location(s) at which particular data is hosted. P2P programs typically provide the ability to search and find information on the P2P network. Search schemes used in P2P networks can generally be divided into unstructured networks which use flooding to perform searches and structured systems.

Gnutella (see http://www.gnutella.com) and Kazaa (see http://www.kazaa.com/us/index.htm) are examples of unstructured P2P networks that use flooding as a search technique. In such networks, a peer that wishes to find information broadcasts a request for information to many other peers in the network. Peers that receive the request message retransmit the message to other peers in the network. In this manner a network peer that has the requested information will eventually be found and will respond. Although such flooding is simple and works well in a highly dynamic network environment, where peers are continuously added and removed from the network, it generates large numbers of redundant requests, which makes it very difficult to scale to networks with very large numbers of peers.

Structured P2P systems such as Chord (see I. Stoica, R. Morris, D. Karger, M. Kaashoek, H. Balakrishnan, Chord: A Scalable Peer-to-Peer Lookup Service for Internet Applications, Proc. of ACM SIGCOMM '01, 2001) and Tapestry (see S. Ratnasamy, P. Francis, M. Handley, R. Karp, S. Shenker, A Scalable Content-Addressable Network, Proc. of ACM SIGCOMM '03, 2003) use search techniques based upon Distributed Hash Tables (DHTs). A DHT-based search technique allows a peer searching for information to locate another peer that hosts the desired information within a bounded (finite) number of message requests. However, DIIT-based methods tightly control both the placement of data and the topology of the network, which results in a high maintenance cost. Furthermore, such networks typically only support searches by identifier and lack the flexibility of keyword searching.

There remains a need for effective, practical systems for cataloging information in distributed file-sharing systems.

### SUMMARY

This invention has several aspects. These aspects can be combined in a data distribution system but also have utility on their own and in combination with other data distribution systems.

The invention provides, without limitation:
Apparatus, systems and methods for hosting and delivering data.
Apparatus, systems and methods for publishing data to a distributed storage and retrieval network.
Apparatus, systems and methods for locating data in a distributed storage environment.

Some embodiments provide cost-effective architectures for large-scale video streaming over the Internet. Such an architecture can exploit the often underutilized storage and upload bandwidth available to personal computers, set top boxes in cable systems, or other nodes on a network to support streaming requests. In an embodiment for streaming video, video files can be split into segments. The segments can be hosted at multiple nodes in the network. More popular and/or more important segments may be hosted at more nodes.

In some embodiments, a Media Segment Distributing (MSD) algorithm is applied to distribute the segments to different nodes. The MSD algorithm determines which segments will be hosted by which nodes based on factors such as the nodes' stability, available upload bandwidth, and recent streaming serve load\frequency.

In some embodiments a category overlay search is used to locate segments required for a streaming session. The search may be used during the streaming session. It is not necessary that all segments be located before playback begins. Requests for segments may be receiver-driven. A receiving node may host material to be delivered to other nodes. Segments of a video file may be divided into blocks to facilitate parallel reception of different parts of a segment from different hosting nodes. Thus upload bandwidth from different hosting nodes can be aggregated. A streaming request may be supported by multiple hosting nodes during a streaming session A Multiple-Source Scheduling (MSS) algorithm may be applied to select the hosting node and order of delivery for blocks in a segment to efficiently aggregate upload bandwidths from multiple hosting nodes and coordinate the downloads from the hosting nodes to timely serve one streaming request.

Some embodiments of the invention apply a category overlay search that can be run on a cluster-based P2P infrastructure that overlies an unstructured network of nodes. This structure permits separation of search traffic from system maintenance. Searches can be performed while restricting the number of messages required to perform the searches.

Searching tasks can be divided by category and by cluster. Load balancing can be further improved by separating searching and indexing traffic.

One aspect of the invention provides a methods for storing a data item for download over a data communication network, advantageously to support streaming of the data item to a receiving node. The methods comprise: dividing the data item into a plurality of segments and identifying a plurality of nodes on the network that are capable of hosting the segments; evaluating suitabilities for hosting the segments of nodes of the plurality of nodes; selecting a subset of the plurality of nodes based upon the corresponding suitabilities; and, forwarding the segments of the data item to the nodes of the selected subset for hosting by the nodes of the selected subset.

Another aspect of the invention provides methods for downloading a data item on a data communication network. The methods may be applied to stream the data item to a receiving node. The data item may comprise a media file, such as a video file. The data item comprises a plurality of segments. The segments are hosted on a plurality of nodes on the network. The methods comprise: downloading all of the segments of the data item and assembling the segments to provide the data item. Downloading all of the segments comprises downloading data from each of a plurality of different ones of the nodes. For at least one of the segments, downloading the segment comprises identifying two or more of the nodes that host the segment and requesting different portions of the segment from each of the two or more of the nodes.

Another aspect of the invention provides systems for storage and delivery of data items. Such systems comprise a plurality of nodes. Each of the plurality of nodes comprises a data processor, a data store accessible to the data processor, and stored computer instructions executable by the data processor. A data communication network interconnects the plurality of nodes. For at least some of the nodes: the computer instructions cause the data processor to retrieve a selected data item by downloading a plurality of segments of the data item and assembling the segments to provide the data item. At least one of the segments comprises a plurality of blocks and downloading the segment comprises identifying two or more other nodes that host the segment and requesting different blocks of the segment from each of the two or more of the nodes.

Another aspect of the invention provides systems for storage and delivery of data items. Such systems comprise a plurality of nodes interconnected by a data communication network. At least some of the nodes comprise: a data store; means for identifying two or more other nodes storing a segment of a desired data item, the segment comprising a plurality of blocks; means for requesting a block of the segment from each of the two or more of the nodes; means for receiving the blocks from the other nodes; and means for assembling the blocks to provide the data item.

In addition to the exemplary aspects and embodiments described above, further aspects and embodiments will become apparent by reference to the drawings and by study of the following detailed descriptions.

### BRIEF DESCRIPTION OF DRAWINGS

Example embodiments are illustrated in the drawings. The embodiments described and shown herein are illustrative rather than restrictive.

FIG. 1 is a schematic view of a system for delivering streaming data.

FIG. 1A is a schematic view of one node of the system of FIG. 1.

FIG. 2 is a flow chart illustrating a method for publishing data to a system like that of FIG. 1.

FIG. 3 shows a cluster having a tree-topology.

FIGS. 4A through 4C show examples of the allocation of responsibility for delivery of blocks of a segment of a media file for round robin, bandwidth-proportional and multi-source scheduling methods respectively. In the illustrated examples, the playback bit rate is 512 kbps.

FIG. 5 illustrates the use of bandwidth aggregation to deliver segments of a data file to a receiving node. In the example of FIG. 5, the playback bit rate is 500 kbps.

FIG. 6 illustrates schematically the use of a ring buffer at a receiving node to buffer received data.

FIG. 7 illustrates schematically a category overlay structure for use in searching for content on a distributed storage system such as a P2P network.

FIG. 8 illustrates schematically a number of nodes within a cluster in an example embodiment.

FIG. 9 illustrates schematically a system for delivering data (e.g. streaming video) to a non-participating device, such as a mobile telephone.

### DESCRIPTION

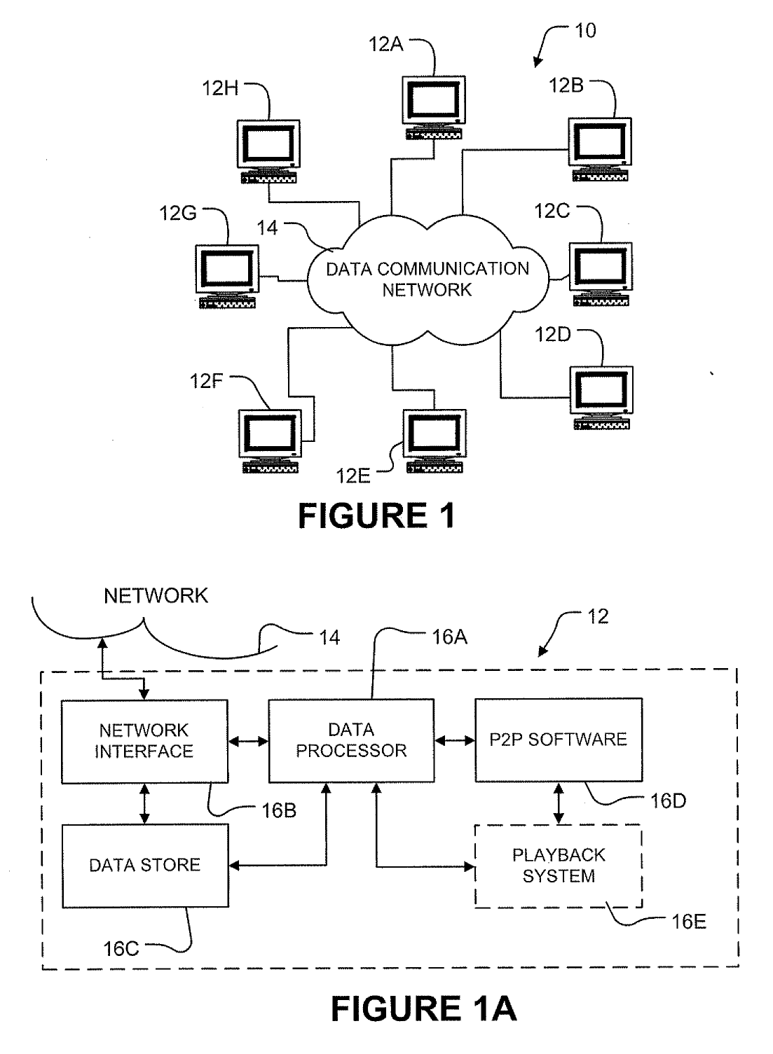

A system 10 for delivering streaming data is shown in FIG. 1. System 10 comprises a plurality of compute nodes 12 (individually identified as 12A to 12H and collectively identified as nodes 12). Nodes 12 each have computing capacity and can access a data store. Nodes 12 may, for example, comprise personal computers, workstations, other networked computing devices, set-top boxes in a cable system, or the like. Nodes 12 are interconnected by a data communication network 14. Nodes 12 can exchange messages and data by way of network 14. While only a few nodes 12 are shown, a system 10 could have any reasonable number of nodes.

FIG. 1A shows schematically a node 12. Node 12 comprises a data processor 16A, a network interface 16B connected to network 14, and a data store 16C. Data processor 16A executes P2P software 16D. Some or all nodes 12 may have a playback system 16E. Playback system 16E uses data retrieved from system 10. Playback system 16E may comprise a monitor or other display capable of displaying still or video images, an audio playback system, a software, hardware, or combined software and hardware system that receives and processes a stream of data from a data item, or the like. Playback system 16E comprises suitable hardware, suitable software or a combination of hardware and software. Any software of playback system 16E may be included, in whole or in part in P2P software 16D.

Publishing Data

Data to be made available on system 10 is published to system 10. The data may be data of any type. In example embodiments, the data comprises:
video data (such as movies, television programming, nearly-live telecasts, and the like);
audio data (such as music, podcasts, and the like);
other media data.

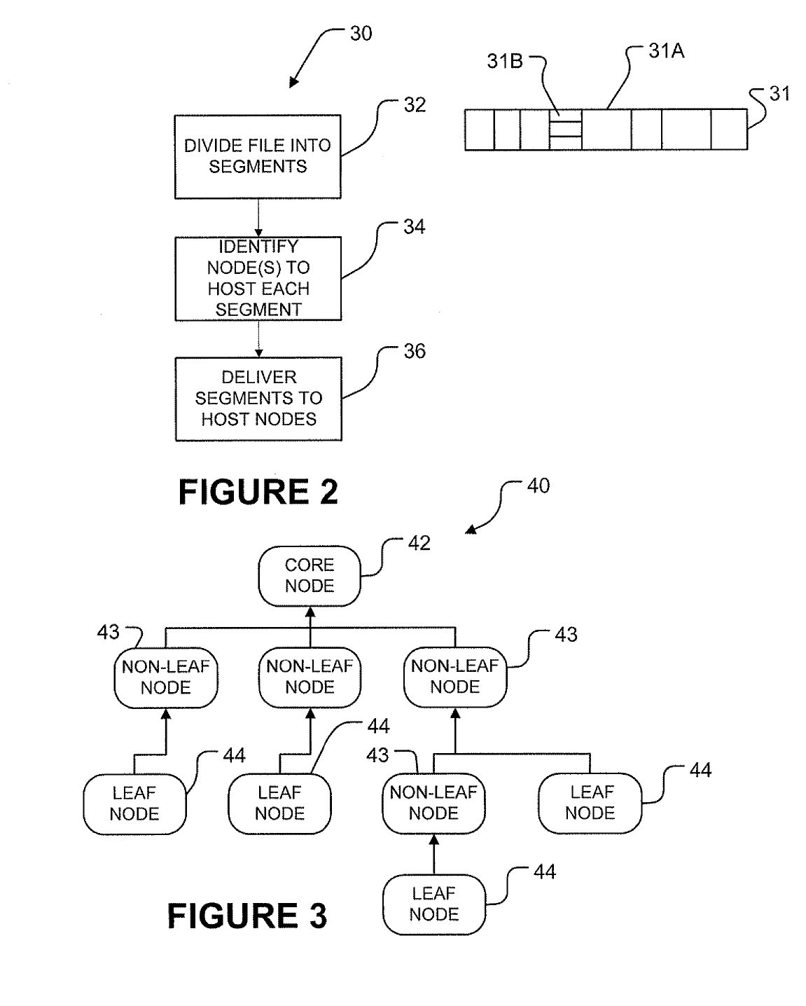

FIG. 2 illustrates a method 30 for publishing data to system 10 for purposes of explanation, the data is a movie to be supplied by on-demand media streaming. The data is provided in a media file 31. At block 32 method 30 splits media file 31 into several segments 31A. The segments may all be equal in size or may be of varying sizes. Making segments of variable size can facilitate finding logical entry points into the data item, such as the beginning of scenes in a video. Segments can be made longer or shorter so that logical entry points into the data item correspond with the beginnings of segments. For example, where it is desired to start playback at a certain scene within a video clip, it is convenient that the beginning of the scene corresponds to the beginning of a segment. The blocks of the segments should be kept constant size.

In preferred embodiments, each segment 31A comprises several blocks 31B. The size of blocks 31B may be adjusted. To facilitate scheduling it is convenient that the blocks within any particular segment are all of the same size. In some embodiments, all of the blocks that collectively make up the segments of a data item are equal in size.

At block 34, method 30 identifies one or more nodes 12 to host each of segments 31A. At block 36, method 30 distributes the segments to different nodes 12. Different nodes 12 may each receive one or more segments. The result of method 30 is that all of the segments 31A of media file 31 are stored in the data stores 16C of nodes 12 of system 10. Preferably each segment 31A is hosted by multiple nodes 12. Segments 31A may be sequential parts of file 31.

Nodes 12 belonging to system 10 may contribute some of their outbound bandwidth and file storage to system 10. The outbound bandwidth and storage that the i^{th} node, Pᵢ, contributes are denoted as Bwᵢ and Stᵢ respectively. The choice of which node(s) to host a segment 31A of a current media file 31 may be based upon a number of factors. For example, the nodes may be selected based upon one or more of:
the bandwidth Bwᵢ made available by the node;
the amount of storage Stᵢ made available by the node;
the stability of the node (i.e. a measure of how likely is it that the node will remain available to system 10); and
the degree to which system 10 has utilized the node recently.
   The likelihood that a node will be selected to host a segment may increase with increases in the available bandwidth, storage of a node and the stability of the node and may decrease with increases in the degree to which the node has been used by system 10.

One possible measure of a node's stability is based upon the lengths of the periods during which the node remains connected to system 10 without interruption. This may be done, for example by computing the smoothed weighted average as follows:
EstimatedStayᵢ(new)=α×EstimatedStayᵢ(prev)+β×CurrentStayᵢ (1)
where CurrentStayᵢ is the length of time that node Pᵢ has participated in system 10 without leaving or failure since it last connected to system 10, EstimatedStayᵢ(new) is a measure of the stability of node Pᵢ taking into account all the history of Pᵢ, EstimatedStayᵢ(prev) is the previous value for EstimatedStayᵢ and α and β are weighting parameters with α+β=1. In one embodiment, a is in the range of 0.8 to 0.9 and β is in the range of 0.1 to 0.2.

A measure of the degree to which system 10 has utilized a node recently may be based upon one or more of the average usage ratio of its contributed bandwidth since it began to participate in system 10 Rᵢ^{usage} and the frequency, Freq^{serve}ᵢ, with which the node has served streaming requests in a recent period.

In an example embodiment, the desirability of a node 12 as a host for a segment is based upon a goodness measure G^{St}ᵢ. In an example embodiment, G^{St}ᵢ has the form:

$$\begin{matrix}{G}_{i}^{St} = {α}_{St} \times \frac{{EstimatedStay}_{i}}{{max}_{1 \leq i \leq m} \{ {EstimatedStay}_{i} \}} + {β}_{St} \times \frac{{Bw}_{i} \times ( 1 - {R}_{i}^{usage} )}{{max}_{1 \leq i \leq m} \{ {Bw}_{i} \times ( 1 - {R}_{i}^{usage} ) \}} - \\ {γ}_{St} \times \frac{{Freq}_{i}^{serve}}{{max}_{1 \leq i \leq m} \{ {Freq}_{i}^{serve} \}}\end{matrix}$$

where α_{St}, β_{St}, γ_{St} are weighting factors, m is the number of nodes participating in system 10. With this formulation, a candidate node that is more stable, has higher available bandwidth and has historically had a lower serve frequency will have a greater G^{St}.

The node wishing to publish file 31 retrieves values for G^{St} of other nodes 12. Block 34 may comprise identifying a number Nc of other nodes that have the highest values for G^{St} and distributing segments 31A among these other nodes 12. In some embodiments, nodes 12 collect the statistics required to compute G^{St} and forward such statistics to a core node. The core node may maintain a data structure associating nodes 12 with the corresponding values for G^{St}. The data structure may comprise a list sorted by G^{St}. Upon request from a publishing node 12 the core node may select N_{c} nodes having the highest values of G^{St} and send the information identifying those nodes back to the publishing node.

In some embodiments, nodes 12 of system 10 are grouped in clusters. Each cluster may have a core node responsible for aggregating values of G^{St} corresponding to nodes 12 belonging to the cluster that the core node is responsible for. In such embodiments, in addition to identifying nodes in its own cluster that have high values for G^{St}, the core node may pass the request to other core nodes. The publishing node may wait for a timeout period Timeoutₚ for responses from core nodes and then assign segments 31A to nodes based upon the values for G^{St}.

In an example embodiment, each cluster of nodes has a tree structure. Apart from the core node, each node in the structure is connected to the core node either directly or via one or more intermediate nodes in the cluster. FIG. 3 is an example of a cluster 40 having a core node 42, a number of non-leaf nodes 43 connected directly to the core node, and a number of leaf nodes 44 that link to the core node by way of their parent nodes.

The organization of cluster 40 is a logical organization and is only relevant to the routes by which information is passed between the nodes of a cluster and the core node of the cluster. The arrangement of nodes into clusters does not necessarily affect and is not necessarily affected by the architecture of network 14 or the geographical locations of any nodes.

In some embodiments, each node periodically sends “alive” messages to its parent node. The alive messages may include information including one or more of EstimatedStay, Bw, R^{usage}, and Freq^{serve}. The parent collects the information contained in the received “alive” messages and periodically sends an aggregate report to its parent along with its own “alive” message. Thus, eventually, the core node will have recent information sufficient to compute G^{St} for every cluster member. The core node may sort the cluster members in descending order of G^{St} and store the result in a sorted candidates list. The core node periodically maintains the sorted candidates list based on more recent information about cluster members.

In addition to being useful for maintaining a central record of G^{St} values, the cessation of alive messages can be used to detect when a node has dropped out of system 10 for some reason.

In some embodiments, after a set of suitable host nodes is identified in block 34, segments 31A are distributed among the host nodes in a round robin manner. A segment distribution algorithm assigns the first segment to the candidate node that has the highest G_{St}, then assigns the second segment to the candidate peer that has the next highest G_{St}, and so on. Once the segments assignment is done, the publishing node sends segments 31A to the assigned nodes 12 on network 14. The nodes 12 store the received segments 31A in their data stores 16C.

At the conclusion of method 30 one or more data files 31 have been divided into segments 31A and segments 31A have each been stored by a plurality of nodes 12 of system 10.

In some embodiments, the number of copies of the first or first few segments 31 of a data file stored in system 10 is greater than the number of copies of subsequent segments. This is desirable where the data stored in system 10 comprises on-line streaming media because, as is known in the art, there tends to be a significantly greater demand for the first few seconds or minutes of a media file than for the rest of the media file. Consumers may start to play a media file and then realize after a few seconds that they are not interested in playing the media file to the end.

In some embodiments, as consumers use system 10 to retrieve data files 31 for playback at their nodes 12 (or for some other purpose), P2P software 16D causes some segments 31A of the retrieved data files 31 to be retained in the data store 16C of the consumer's node 12. These retained segments can then be made available to other nodes on system 10. This is desirable since it automatically causes more segments of popular data files 31 to be present on system 10. The selection of which segments 31A to be retained may be random or quasi-random. The selection may be biased such that the first few segments 31A have greater odds of being retained than other segments.

In some embodiments, all segments of a data item are retained in data store 16C at least for a period of time. The availability of segments in local data store 16C (which can be accessed relatively very rapidly) permits rapid fast-forwarding or rewinding within the portion of the data item for which segments have been stored in local data store 16C of the receiving node. As long as the segments are retained by the receiving node, the data item (e.g. a video) can be played at the receiving node without the need to download the segments again (subject to the possibility that P2P software 16D may be configured to permit playback of a data item only a certain number of times or only during a certain period).

In some embodiments, complete copies of data items 31 that are available on system 10 may be made available in selected nodes that are very stable (e.g. are on-line continuously). Such nodes may be accessed as a last resort to provide segments that are not otherwise available on system 10.

Requesting and Receiving Data

System 10 may be configured to permit retrieval of data from system 10 in any of a wide range of alternative ways. In some embodiments, when a node (a receiving node) requests a data file from system 10, the receiving node may first identify other nodes on system 10 that host the first segment of the desired data. The first segment may be downloaded from one or more such nodes while the requesting node prepares to download the remaining segments of the desired data. Identifying nodes that host required segments of the desired data may be performed using any suitable searching mechanism. One suitable search mechanism is described below.

The receiving node may determine if the desired data (e.g. a media file) can be streamed to the receiving node by the nodes contained in the search results (hosting nodes). If the receiving node determines that the media file can be streamed, the receiving node may selfishly determine the best hosting nodes to receive the media file from. The receiving node may apply a scheduling method to aggregate bandwidths from the selected hosting nodes and coordinate them to stream segments of the media file to the receiving node beginning with the first segment of the media file.

If the receiving node determines that the media file cannot be streamed to it, the request is rejected. Examples of situations in which the request may be rejected are cases in which:
not all segments of the desired media file can be found; and
the bandwidth of the hosting nodes the host one or more segments of the media file is insufficient for streaming.

In some embodiments, playback can commence before all segments are available (or even exist). For example, in a nearly live broadcast, media segments are generated and published to system 10 in real time. After the first few segments have been made available on system 10, users can commence playing the media segments as described herein. As consumers play back the nearly-live media, the P2P software 16D running at the consumers' nodes locates and streams additional segments 31A of the nearly-live media to the consumers' nodes.

As noted above, each segment 31A is preferably hosted by a plurality of nodes and comprises a plurality of separately-transmittable blocks. The receiving node identifies the best set of other nodes from which to source each segment.

The scheduling problem may be articulated as follows. Suppose a segment contains N blocks {B₁, B₂, . . . , B_{N}} and the receiving node has identified M hosting nodes {P₁, P₂, . . . P_{M}} to supply the segment. Given the bandwidths contributed by the hosting nodes {Bw₁, Bw₂, . . . , Bw_{M}}, where the sum of the contributed bandwidth is at least equal to Br (the playback bit rate of video), how should one divide among the hosting nodes the responsibility for transmitting the blocks of the current segment to the receiving node to achieve a minimum initial buffering time, as well as download each block as early as possible.

Some embodiments employ a ‘round robin’ (RR) methodology. In such embodiments, hosting nodes for a segment are numbered from 1 to M and blocks are assigned to the hosting nodes in order from 1 to M. RR treats each hosting node equally by making it equally likely that each hosting node will be assigned the same number of blocks, no matter how much bandwidth each hosting node contributes to the streaming session. Thus some bandwidth contributed from hosting nodes that have more contributed bandwidth may be wasted, while hosting nodes that have relatively little bandwidth available for the purposes of system 10 may be assigned undesirably many blocks.

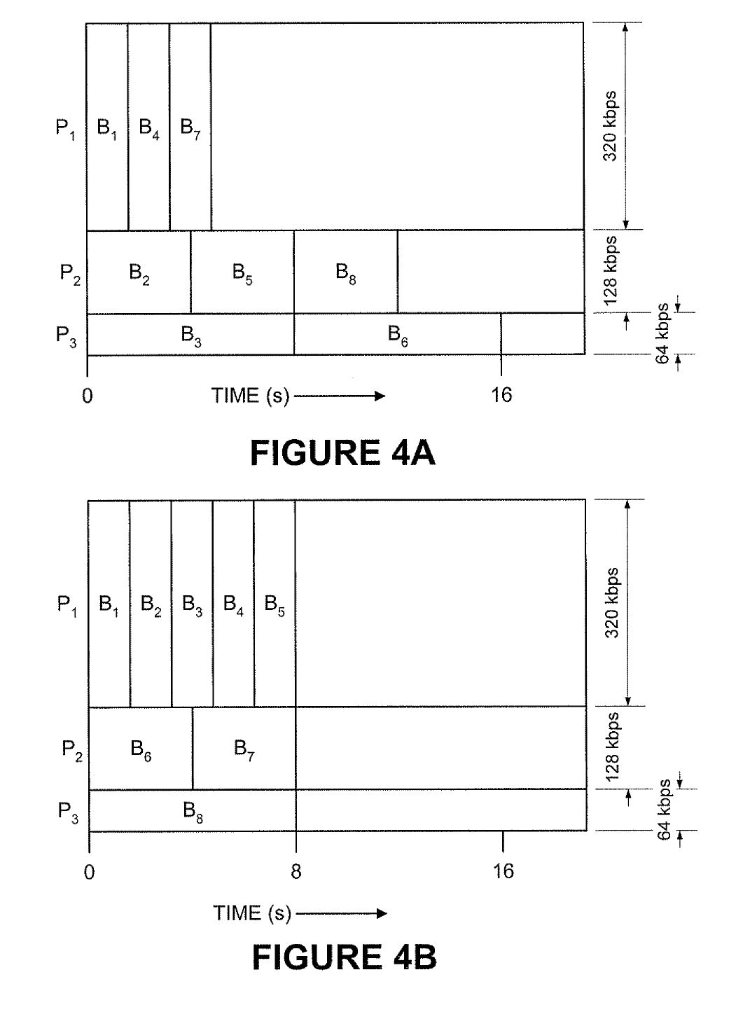

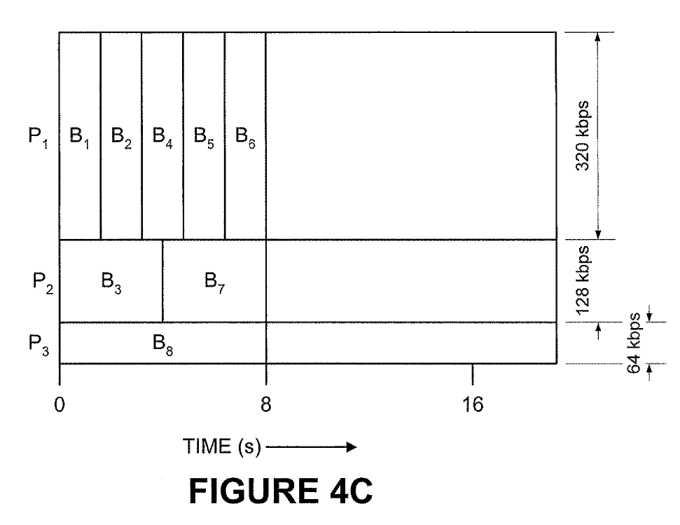

FIG. 4A illustrates an example of assigning to three hosting nodes responsibility for delivering 8 equal-sized blocks using RR. Suppose Br, the playback bit rate of the video is 512 kbps, and each block contains 1 second of the video content. Suppose that hosting node P₁ contributes a bandwidth of 320 kbps (⅝×Br), P₂ contributes a bandwidth of 128 kbps (¼×Br), and P₃ contributes a bandwidth of 64 kbps (⅛×Br). Delivering all 8 blocks to a receiving node takes 16 seconds when the blocks have been assigned to hosting nodes by RR.

Other embodiments employ a bandwidth proportional method (BP). In BP methods, blocks are assigned to hosting nodes in proportion to the bandwidth available at each hosting node. In this approach, hosting node Pᵢ sends Bwᵢ/Br blocks, starting at the next block after the last block assigned to hosting node Pᵢ₋₁. This approach utilizes the bandwidth fully from each hosting node when sending blocks. FIG. 4B illustrates the application of BP scheduling to the example of FIG. 4A. One disadvantage of BP scheduling is that the first few blocks are all assigned to one node. Only the bandwidth of that one node is used to deliver these initial blocks. If it is desired to initially buffer several blocks then the time taken to buffer those blocks might be longer than would be the case if delivery of the initial blocks were assigned to multiple hosting nodes.

Other embodiments apply multi-source scheduling (MSS) which combines advantages of both RR and BP. MSS generates a schedule in which blocks are assigned to hosting nodes in a roughly round robin manner. In each round, the blocks are assigned in proportion to the bandwidth contributed by the hosting nodes.

In MSS, hosting nodes may be sorted by their bandwidth Bw in descending order. For a given hosting node Pᵢ, the time Tᵢ is the earliest time at which the hosting node could commence sending the current block. If the hosting node is not already sending a block then Tᵢ is the current time. If the hosting mode is already sending one or more blocks then Tᵢ is the time at which the hosting node will finish sending the blocks that it has already committed to send. Tᵢ may initially be set to zero.

The responsibility for delivering blocks may be assigned to hosting nodes in order of the block number, starting with the first block, B₁. Responsibility for delivering each block is assigned to the hosting node that will complete delivery of the block first (taking into account the blocks that have already been assigned to the available hosting nodes). To assign the current block, B_{current}, the receiving node may compute the estimated finish time for the block for each of the hosting nodes. The estimated finish time may be given by:

$${T}_{finish ( i )} = {T}_{i} + \frac{Size}{{Bw}_{i}} \qquad ( 3 )$$

where T_{finish(i)} is the estimated finish time for the hosting node Pᵢ, and Size is the size of the current block.

Next, the hosting node having the minimum estimated finish time is identified. Responsibility for the current block is then assigned to the hosting node for which the finish time is minimum. The time for the selected hosting node is then set to have a new value equal to T_{finish(i )}. This process may be repeated for each block in order until responsibility for the last block in the current segment has been assigned to a hosting node.

Multiple-Source Scheduling (MSS) assigns blocks to hosting nodes based on their estimated finish times for sending a current block. The supplier that has the minimum estimated finish time will be assigned responsibility for delivering the current block. This approach ensures that blocks are assigned to hosting nodes in proportion to their contributed bandwidth, and each block is downloaded by the receiver as early as possible after the previous blocks are received.

FIG. 4C illustrates the application of MSS scheduling to the example of FIG. 4A. After B₅ has been assigned, any of the three hosting nodes could finish delivery of the next block, B₆, at the same time. In the illustrated example, block B₆ has been assigned to node P₁. However, block B₆ could have been has been assigned to one of nodes P₂ or P₃ without affecting the finish times for any blocks.

The performance of the RR, BP and MSS scheduling methods may be compared by comparing FIGS. 4A to 4C. It can be seen that completing the delivery of the 8 blocks shown in these examples takes 16 seconds when RR scheduling is used while BP and MSS scheduling can complete delivery of the same blocks in only 8 seconds. The BP and MSS methods differ in the time taken to complete delivery of the first few blocks. If the number of initial buffering blocks is three, RR takes 8 seconds to complete delivery of the first three blocks. By comparison, BP takes 4.8 seconds to complete delivery of the same three blocks while MSS takes only 4 seconds. This example demonstrates that compared to RR and BP, MSS uses less time to download all the blocks, and achieves a small initial buffering time.

When the streaming of the first segment is underway, the receiving node may repeat the process to download the second and subsequent segments 31A, until the entire media file 31 has been streamed to the receiving node.

In some embodiments, the media file or other data item being retrieved comprises metadata. The metadata may, for example, identify he segment(s) of a video file corresponding to particular scenes. The metadata may contain more detailed information relating to the information content of individual segments. For example, for a video file, the metadata may identify segments in which a certain actor or actresses appears. Such metadata can permit intelligent search for content. The metadata may be included in one or more of the first few segments of a data item so that it is immediately available for use by a player. A player may be configured to play the data item (for example, by displaying video images and accompanying audio, playing back audio, displaying sequences of images, or the like) provide intelligent fast-forward or rewind to a particular logical scene by searching the metadata to identify the segment at which the desired scene commences and then locating, buffering if necessary, and commencing playback at the identified segment.

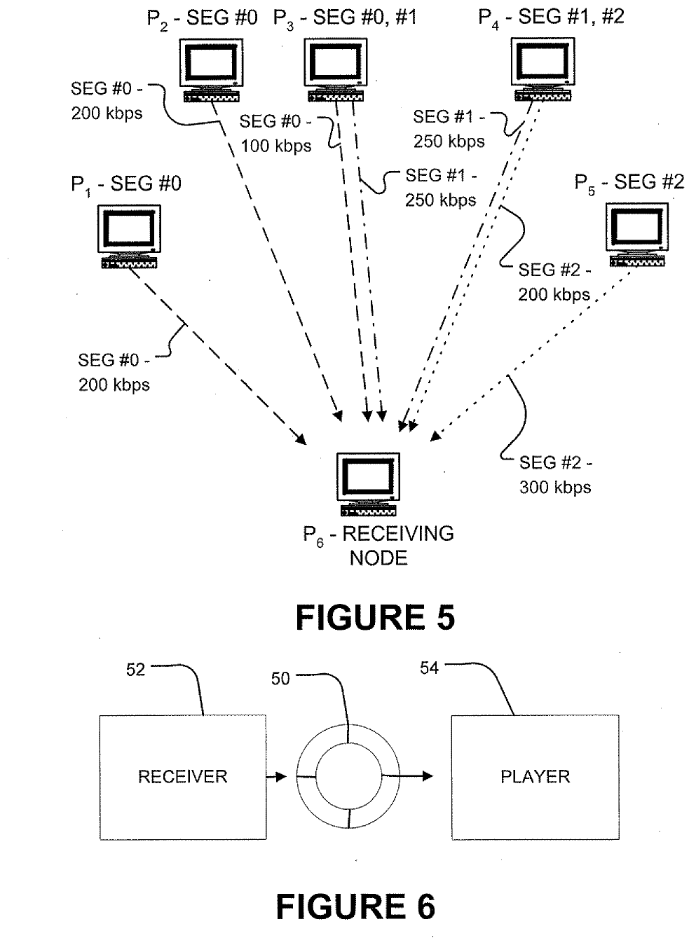

FIG. 5 shows an example of the delivery of segments of a video file using system 10. Suppose receiving node P₆ wants to watch a video whose playback bit rate is 500 kbps. Receiving node P₆ searches for segment #0 of the video and finds that P₁, P₂, P₃ have segment #0. Receiving node P₆ then selects P₁, P₂, P₃ as the hosting nodes for segment #0 and aggregates bandwidths from P₁, P₂, P₃ to stream segment #0. Segments #1 and #2 are streamed in the same way. After the streaming session of a segment is over, the receiving node may cache the segment in its contributed storage. The receiving node may subsequently serve as a host for any cached segment(s).

Once the receiving node generates a schedule for downloading the blocks that make up a segment, it may send the schedule to the selected hosting nodes. When a hosting node receives the schedule, it may send the assigned blocks to the receiver according to the schedule. The blocks may be delivered using any suitable protocol over network 14. For example, the blocks may be delivered using UDP (user datagram protocol). The participating nodes may perform TCP-friendly congestion control over the UDP connection.

As shown in FIG. 6, a receiving node 12 may maintain a ring buffer 50. The receiving node may insert segments into the ring buffer 50 as they are received from hosting nodes. In FIG. 6, the parts of receiving node 12 that serve to receive blocks from hosting nodes are indicated generally by 52 and the player that plays video or other media represented by the received blocks is indicated generally by 54. The size of the ring buffer may be given by α_{buff}×N_{sche}×blk_size, where α_{buff} is a parameter with α_{buff}>1 and blk_size is the size of a block. When the receiving node has received each block, it writes the block to the correct position within ring buffer 50.

In order to accommodate the transient effects of streaming packets arriving late or the selection of new hosting nodes when hosting nodes leave system 10 or fail, receiving node 12 may buffer at least S_{initBuff} blocks before the media file playback starts (initial buffering). After the initial buffering time, the receiving node may continuously read data from ring buffer 50 and play the media file.

During a streaming session, some hosting nodes may leave system 10 or fail, or incoming streaming rates from one or more hosting nodes may decrease due to network congestion. In such cases, the receiving node may select one or more substitute or additional hosting nodes from which the required segments can be obtained. For example, if a hosting node fails or leaves system 10 during a streaming session then the receiving node may select another hosting node to substitute for the leaving/failing hosting node. The receiving node may generate a new schedule for delivery by the new set of hosting nodes of blocks that have not been received. The receiving node sends the revised schedule to the nodes of the new set of hosting nodes. Once they the revised schedule has been received by the hosting nodes of the new set of hosting nodes, the new set of hosting nodes may send the assigned blocks to the receiving node in the order specified by the schedule. This process may be referred to as “supplier switching”.

While supplier switching is occurring, the aggregate bandwidth may be less than the required playback bit rate, and thus the receiving node may experience buffer underflow. S_{initBuff} may be chosen to be large enough that playback can continue without interruption even if supplier switching occurs.

In some embodiments, the receiving node 12 monitors the status of ring buffer 50 and tracks the blocks received during a streaming session. Every block should be received at least T_{adv} seconds before that block is scheduled for playback. If the block has not been received by this time then the block may be identified as “lost”, and the receiving node may send a request to the corresponding hosting node to re-send the lost block.

During the streaming session, the receiver may monitor the rate at which data is being received from each hosting node. If the receiving node detects that the incoming bit rate from a hosting node is decreasing for a period T_{dec}, or it is notified or detects the departure or failure of a hosting node, the receiving node may perform supplier switching

It can be appreciated that the methods and apparatus described above can be applied to downloading data items. Advantageously the methods and apparatus can be applied to streaming data items. Streaming differs from other downloading operations in that playback (or other use) of the data item is commenced before all parts of the data item have been received. Further, where the data item is streamed, it is not necessary to keep parts of the data item that have already been played back (or otherwise used).

The foregoing description assumes that receiving nodes have access to some mechanism for identifying nodes of system 10 that host segments of data files 31 that are required by the receiving nodes. Any suitable search mechanism may be used to perform this function. A novel search mechanism that may be used to perform this function is described below. This novel search mechanism may also be applied for other purposes.

Apparatus and methods for searching for content in a distributed network such as a P2P network provides separable mechanisms for searching for content in each of a plurality of categories. These mechanisms may be described as category-specific overlays. Such overlays may be provided on an unstructured P2P system. Specific searches may be limited to the applicable overlays. This conserves computing resources and limits the number of messages that must be passed across a data communication network to perform a search.

Nodes may be assigned to maintain content indexes for predefined categories. Such nodes may be referred to as “agent nodes” for their respective categories. The categories are related to the network content and may include but are not limited to categories that may describe media. For example, where a system 10 hosts movies, the categories may include categories such as “action”, “comedy”, “historical”, and so on.

Where it is desired to use the search system for locating hosting nodes that host specific segments of hosted files, categories may be provided for each set of segments. For example, a category may be provided for each of the 1^{st}, 2^{nd}, 3^{rd}, 4^{th} . . . etc. segments of content hosted on a system 10. A receiving node searching for hosting nodes that have a copy of the first segment of a particular file would look up the file in the category for the 1^{st} segments and so on. Categories may also be based upon factors in addition to the ordinal position of a segment. For example, categories may be based upon both a classification of the subject matter of data items and the ordinal position of the desired segment.

The agent node in each category maintains a keyword list table (which may be called a “content index table”) for some or all of the information belonging to the category or categories to which it has been assigned. The content index table may comprise a data structure that stores keyword lists for all the contents (e.g. stored files) belonging to a given category. For example, each entry in the content index table may contain the following information: Category, Keyword List, Owner node. “Category” specifies the category to which the content has been assigned. “Keyword List” includes one or more keywords germane to the content. “Owner Node” specifies on which node the information is stored. For example, an entry <C_{A}, KL, N_{X}> means that node N_{X} has content which goes with the keyword list KL belonging to the category C_{A}. Content index tables are only maintained at agent nodes.

In some embodiments, the nodes in a P2P network, such as system 10 are divided into clusters. Each cluster may include one, two or more nodes. Different clusters may include different numbers of nodes. Each cluster maintains agent nodes for each category. A single node may serve as an agent node for multiple categories.

In some embodiments, the clusters may have a tree topology. FIG. 3 shows an example of such a tree topology. In such embodiments, each cluster has a central or “core” node. Apart from the core node, each node in the cluster has a parent node and is connected to the core node either directly or by way of one or more parent nodes.

The agent nodes for a specific category that belong to different clusters within system 10 may be associated with one another. The association may comprise links between the agent nodes. A link may comprise a record of the address or other contact information of one agent node for a category maintained at another agent node for the category. In some embodiments, each agent node has an overlay link list listing addresses of one or more agent nodes for the category that are in other clusters. This association of agent nodes based on their assignment to a common category may be referred to as a “category overlay”. Multiple category overlays can be constructed. Each category overlay corresponds to a category. Because clusters may contain different numbers of nodes, certain nodes may belong to multiple category overlays.

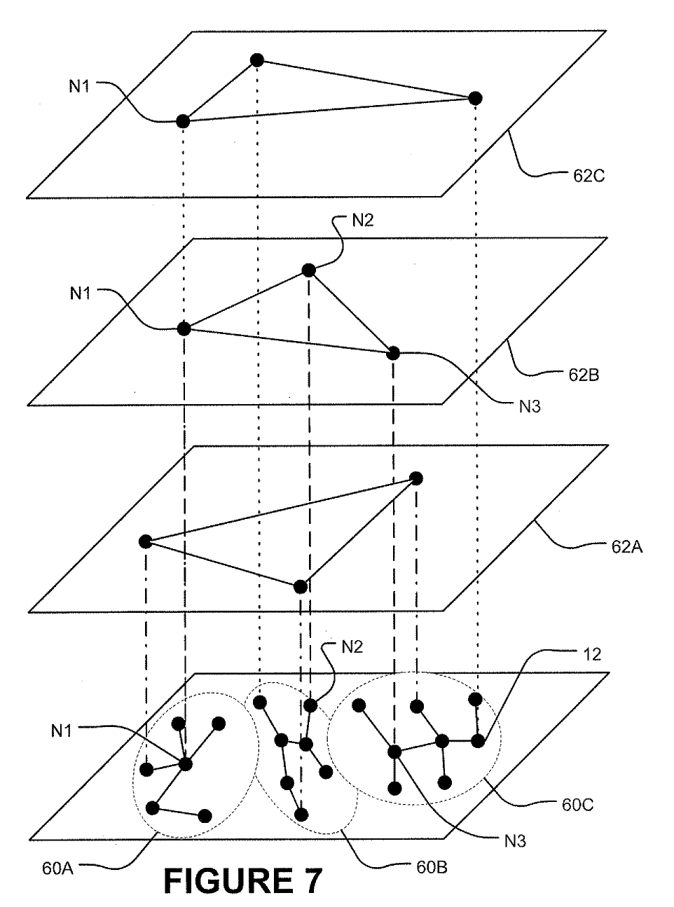

FIG. 7 shows an example of nodes in a system 10 organized into multiple clusters 60 (identified individually as 60A, 60B, and 60C) and multiple category overlays 62 (identified individually as 62A, 62B, and 62C). In each cluster, one agent node is assigned to each of three predefined categories: Ca1, Ca2 and Ca3. For example, in cluster 60A, node N1 is associated with category Ca2; in cluster 60B, node N2 is associated with category Ca2; and in cluster 60C, node N3 is associated with category Ca2. Since nodes N1, N2 and N3 are agent nodes for category Ca2, they may be associated with one another to form the category overlay 62B. Category overlays 62A and 62C are similarly formed from the agent nodes for categories Ca1 and Ca3 respectively.

In some embodiments, each node 12 maintains a category table, which stores mappings between categories and the corresponding agent nodes in the cluster to which the node belongs. Each entry in the category table may contain the following data: <Category, Agent Node, Timestamp>. For example, an entry <CA, N_{X}, Ti> means that at time Ti, node N_{X} became associated with category CA. Every category has a corresponding entry in this category table and every node maintains a copy of the category table.

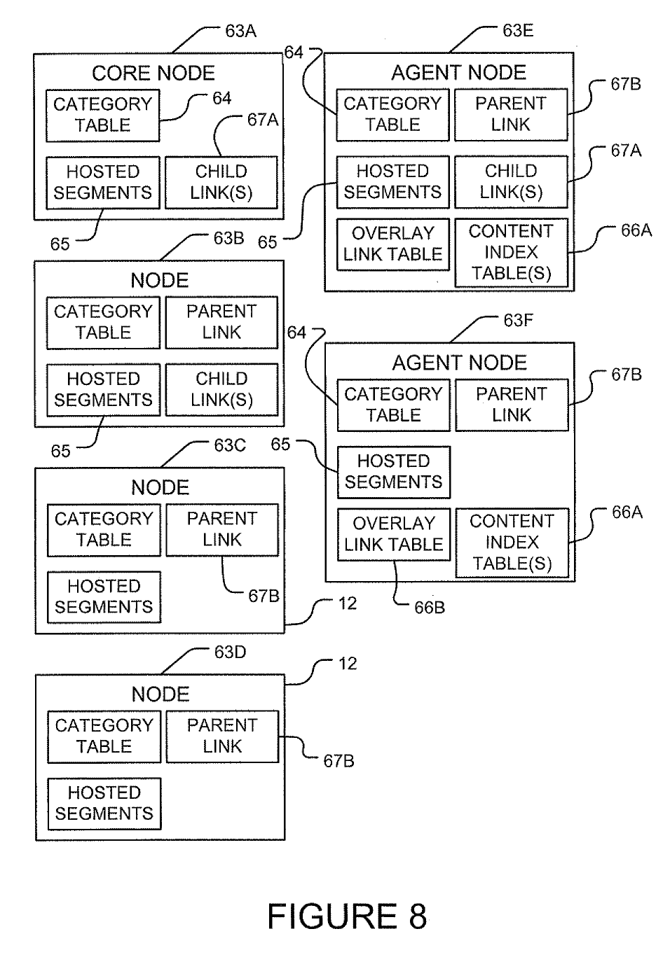

FIG. 8 shows a few nodes of a cluster in an example embodiment (which would typically have many more nodes). One node 63A is a core node for the cluster. Each node has a category table 64 and may have hosted segments 65 of data items. Category tables 64 include links to agent nodes 63E and 63F. Agent nodes 63E and 63F each include one or more content index tables 66A and one or more overlay link tables 66B. Core node 63A, and other nodes that have child nodes in the topology of the cluster have links 67A to their child nodes. All nodes other than core node 63A have a link 67B to a parent node. In the illustrated embodiment, parent and child links define the topology of the cluster while the overlay link tables define the topology of the category overlays.

To retrieve information from the system, a node may issue a query specifying a category, as well as a list of one or more keywords associated with the information to be retrieved from the system. The requesting node directs the query to the agent node associated with the specified category. The requesting node may locate the agent node by looking up the category in its category table. The agent node receives the query and then searches its content index table for information which matches the keyword(s) in the query. The agent node returns its results to the query initiator.

The agent node may additionally propagate the query within the corresponding overlay. Each agent node in the overlay that receives the query may search its content index table for information that matches the keyword(s) in the query and returns results of the search to the query initiator. The search results include a list of the nodes storing information that satisfies the query.

An example search for information belonging to the category CA is as follows:
The query initiator N_{X} looks up its category table to find the agent node for category CA.
Suppose the agent node is node N_{Y}. Then node N_{X} contacts node N_{Y}.
If N_{Y} is alive and is the correct agent node for category CA, then N_{Y} searches its content index table with keyword list KL received from N_{X} and returns results to N_{X}.
If N_{Y} is not the right agent node then N_{Y} returns the address of the agent node according to the category table maintained by N_{Y}. If the information in the category table of N_{Y} is more recent than the information in the category table of N_{X} then N_{X} updates its category table and tries again.
If N_{Y} is dead, then N_{X} contacts the parent node of N_{Y}, N_{Z}. If N_{Z} cannot find the correct agent node for category CA N_{X} then contacts the parent node of N_{Z} and so on until N_{X} contacts the core node. If the core node still cannot identify the agent node for category CA or the core node is dead, then the query will be flooded to every node within the cluster.
During above operations, once the agent node for category CA has received the query, the agent node executes the query and also looks up agent nodes for category CA in other clusters in an overlay link list. The agent node then propagates the query to the corresponding agent nodes contained in the overlay link list. When another the agent node receives the propagated query, the agent node checks to determine whether the query is being received for the first time. If so, the agent node executes the query and also looks up agent nodes for category CA in other clusters in its overlay link list. The agent node then propagates the query to the corresponding agent nodes contained in the overlay link list. If an agent node has received and processed the query previously then it may ignore the query.
Each agent node that processes the query returns results of the query to the requesting node.

In this method, a query needs only to be propagated within the overlay corresponding to the category to which the query relates. This is much more efficient than propagating the query by way of flooding to all nodes in the system. Each category overlay need contain at most N peer nodes, where N is the number of clusters. Therefore, as long as a query is propagated within its category overlay, very few peers (comparing with all the peers in the network) will be contacted with the query.

For example, a user may wish to find a file containing music by a country music singer. The node operated by that user may issue a query in the “country” category. The query may comprise a list of keywords that includes the singer's name or the song title. The agent node(s) may return the addresses of nodes hosting information matching the query.

As another example, a receiving node may use a category overlay search to identify other nodes hosting a particular segment 31A of a data file 31 that is to be streamed to the receiving node. For example, if the required segment is the N^{th} segment, the receiving node may identify an agent node associated with the category for the N^{th} segments of files and may then send a query to that agent node in which the category is the “N^{th} segment” category and the keyword is an identifier for the required file. The search returns one or more lists of nodes that host the N^{th} segment of the required file.

It may be desirable to impose various limits on the size and structure of clusters. For example, all nodes belonging to a cluster may be required to be within N hops distance from the core node. This N hops distance may be called the cluster range limit. The number of hops from a member node to the core node by way of the tree structure may be called the range of the node. Clustering may be achieved by permitting nodes to request to join existing clusters. For example, a node that comes on-line may be programmed to contact a node in another cluster and request to join that other cluster. If the range of the contacted node is less than the cluster range limit then the requesting node may join the existing cluster. Otherwise, the requesting node may create a new cluster (i.e. become the core node for the newly created cluster). In the alternative, the requesting node may attempt to join another cluster or to find another node that has a range smaller than the cluster range limit.

Clusters should ideally be of similar sizes. The sizes may be regulated, for example, as follows:
(1) each cluster may have a cluster size limit. Once a cluster reaches this limit, it may reject any request from another node to join that cluster (until one or more existing cluster members leave).
(2) when a node communicates a request to join a cluster to a boundary node of the cluster that has a range equal to the cluster range limit then, instead of being forced to create a new cluster, the boundary node may forward the request to its parent. If the cluster size is less than a parameter called Full_Fraction, the node may join this cluster. The higher the parameter Full_Fraction is set, the fewer clusters will be created. With this parameter, the probability for a node to join an existing cluster is increased, thus decreasing the possibility of generating small clusters.
(3) to be a core node, a node should satisfy some qualifications, such as having sufficiently powerful computing ability, high bandwidth, long stay period, etc. to function effectively as a core node.
(4) the core node of each cluster may periodically check the cluster's size. If the cluster has a size is below a threshold value then the core node may try to find another suitable cluster and merge into that cluster. The threshold value may be set to encourage the elimination of small-sized clusters.

When a new cluster is created, the core node for the cluster may initially be the agent node for all categories in the new cluster. As other nodes join the new cluster the core node may migrate some categories to the other nodes. These other nodes may migrate categories to still other nodes. For example, any agent node within a cluster may migrate some of its categories to a newly-joined node that joins the cluster as a child of the agent node. An agent node may cause some categories to be migrated to other nodes in the cluster if its load becomes too high.

The category tables maintained by nodes in a cluster may become out of date and inconsistent with one another if an agent node in the cluster migrates one or more categories to some other node(s). Initially, only the agent nodes and the nodes to whom the categories have migrated will have up-to-date information regarding the current agent node for the migrated category.

A periodical aggregation report scheme may be implemented to solve this inconsistency problem. Every participating node may periodically sends a category update report to one or more randomly-selected neighbor nodes. The category update report may include the latest N updates (or category migration events) known to the reporting node, as well as M random entries from the category table of the reporting node. Upon receiving the category update report, a recipient node may update its own category table based on the timestamps in the category update report.

When a node shares information with the system the node may identify the applicable agent node by looking up the category with which the information is associated in its category table. The node may then generate a message the agent node. The message may include a category, a list of one or more keywords associated with the information and may advise the agent node that the information assigned to the category is available for access by other nodes. Upon receiving this message, the agent node may store the keyword list and the address of the hosting node in its content index table.

In some embodiments, the category and keywords are selected by a user of the hosting node. The user may select the category from a predefined category list and may select a number of keywords to describe that information. The number of keywords may be one or greater than one.

It can be appreciated that the searching methods and apparatus described herein can permit searching to be shared among a wide range of nodes in a system 10. Searching duties can be distributed among a number of nodes that is as large as the number of categories (which can be large) times the number of clusters of nodes in system 10. Infrastructure maintenance duties, such as indexing, adapting system 10 to incorporate new nodes or to deal with the departure of existing nodes can also be distributed over a large number of nodes.

The methods and apparatus disclosed herein may be combined or implemented alone to provide search or streaming capability for fields of use that include storage area networks video, image, music, and data file searching and streaming, and more generally the sharing, streaming or search of any data that can be categorized or divided into segments.

In an example embodiment, the nodes include set top boxes in a cable television system, Such set top boxes have desirable attributes for nodes as a system as described herein because such set top boxes:
tend to be stable (are typically always on-line);
are interconnected by a managed cable television data communication network that provides high bandwidth data communication between nodes;
have available relatively large amounts of data storage; and,
are connected directly to playback systems (e.g. televisions) that are increasingly typically high-quality playback systems (such as high-definition television sets).
   Further, the system is advantageous in an embodiment in which receiving nodes comprise set top boxes, other computers interconnected by a cable television system, or other nodes in a network that provides greater bandwidth for downloading data to a node than the network provides for uploading by the node. Individual hosting nodes can upload data at relatively low rates. The data streams from multiple hosting nodes are delivered to a receiving node at a significantly higher aggregate bandwidth.

A system 10 as described herein may be used to provide streaming media (or other data items) to devices that are not themselves nodes that participate in system 10. For example, such as system may be used to deliver data items to personal digital assistants (PDAs), mobile telephones, or the like. This may be accomplished, for example, by providing proxy nodes in system 10. A proxy node receives data from system 10, as described above, but instead of, or in addition to playing back (or otherwise using) the data item itself, the proxy node forwards data received from system 10 to another device.

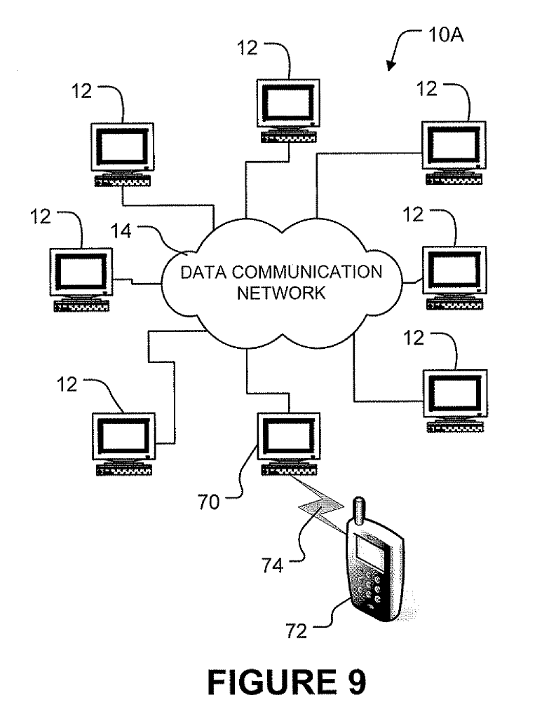

FIG. 9 shows a system 10A which includes a proxy node 70. Proxy node communicates with other nodes 12 as described above to receive data items, Proxy node 70 also communicates with a non-participating portable device 72 by way of a communication link 74. Communication link 74 may include a wireless connection. Proxy node 70 interacts with the rest of system 10A on behalf of device 72 and forwards received data to portable device 72 by way of communication link 74. Thus, for example, a user of a mobile telephone can search for video in system 10A and then play back video at the mobile telephone. In some embodiment, transcoding is performed at proxy peer 70 to reduce the bit rate of the data item to a level appropriate for the device 72 and/or the communication link 74.

It can be appreciated that embodiments of the category search methods and apparatus described herein are readily scalable and can provide good load balancing among nodes (by separating system maintenance, indexing and search responsibilities and distributing them over various nodes). In such embodiments, it is not necessary to provide “super nodes” capable of independently handling all search services for an entire system. It can also be appreciated that in some embodiments, different nodes are associated in groups in two different ways. On one hand, nodes are associated into clusters. Maintenance tasks such as tracking which nodes are agent nodes for each cluster may be managed using the topology of the clusters. On another hand, agent nodes are associated in category overlays. Searching tasks such as locating nodes that hose a desired segment of a data item may be managed using the topology of the appropriate category overlay.

Alternative embodiments of this invention combine the category overlay search methods disclosed herein with any suitable media file storage and retrieving method including those known in the art. The category overlay method provides large-scale efficient keyword search services based on the P2P network model. Therefore, this method can provide a search infrastructure for any system that requires keyword search services. One such example is a file sharing application. Some additional applications of the distributed data storage and retrieval technology described herein are:
Archiving disk images—an image of data on a disk or other storage device may be broken into segments and stored in a distributed system as described herein. In restoring the image, the segments may be downloaded sequentially from multiple peer sources. Each segment may be located by way of a category overlay search in which the category is, or is based at least in part on, the ordinal position of the segment.
Large data files such as, without limitation, 3D animation files or 3D holographic projection files or large high-resolution GIS maps of the earth can be stored and retrieved by the systems and methods described herein.

Other alternative embodiments combine the disclosed on-demand media streaming methods with any search infrastructure that provides efficient keyword search services.

Where a component (e.g. a processor, data link, device, circuit, player, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

While a number of exemplary aspects and embodiments have been discussed above, those of skill in the art will recognize certain modifications, permutations, additions and sub-combinations thereof. It is expressly intended that all methods and apparatus comprising any new useful and inventive features, combinations of features or sub-combinations of features disclosed herein are aspects of the invention, whether or not included in the original claims. It is further expressly intended that the features of the different example embodiments disclosed herein may be combined in workable combinations in addition to those combinations that are expressly disclosed herein. It is therefore intended that the following appended claims and claims hereafter introduced are interpreted to include all such modifications, permutations, additions and sub-combinations as are within their true spirit and scope.

What is claimed is:

1. A method for storing a data item for download over a data communication network, the method comprising:
dividing the data item into a plurality of segments and identifying a plurality of nodes on the network that are capable of hosting the segments;
evaluating suitabilities for hosting the segments of nodes of the plurality of nodes;
selecting a subset of the plurality of nodes based upon the corresponding suitabilities; and,
forwarding the segments of the data item to the nodes of the selected subset for hosting by the nodes of the selected subset.

2. A method according to claim 1 comprising, for at least some of the segments, forwarding the segments to each of a plurality of nodes of the selected subset for hosting by each of the plurality of nodes.

3. A method according to claim 1 wherein evaluating the suitabilities is based at least in part upon available bandwidths of the nodes.

4. A method according to claim 1 wherein evaluating the suitabilities is based at least in part upon a measure of the reliability of the nodes.

5. A method according to claim 4 wherein the measure of the reliability of the nodes is based in part on a connect-time of the node.

6. A method according to claim 5 wherein the measure of reliability is a cumulative measure of reliability based upon the value EstimatedStay given by:
EstimatedStayᵢ(new)=α×EstimatedStayᵢ(prev)+β×CurrentStayᵢ
where α and β are constants with α+β=1 and β<0.2, Estimated Stayᵢ(NEW) is the current value of the cumulative measure of reliability, Estimated Stayᵢ(Prev) is a value of the cumulative measure of reliability at the time that the node most recently came online, and CurrentStayᵢ is a length of time that the node has been continuously online and participating in a system on which the method is being performed.

7. A method according to claim 1 wherein evaluating the suitabilities is based at least in part upon a measure of the frequencies with which data has been previously downloaded from the nodes.

8. A method according to claim 1 wherein evaluating the suitabilities comprises ranking the nodes according to a criterion that increases with a bandwidth of the node available for uploading data and decreases with a measure of a frequency with which data has been previously downloaded from the node.

9. A method according to claim 8 wherein evaluating the suitabilities comprises computing a goodness value for nodes of the plurality of nodes, the goodness value given by:
$$\begin{matrix}{G}_{i}^{St} = {α}_{St} \times \frac{{EstimatedStay}_{i}}{{max}_{1 \leq i \leq m} \{ {EstimatedStay}_{i} \}} + {β}_{St} \times \frac{{Bw}_{i} \times ( 1 - {R}_{i}^{usage} )}{{max}_{1 \leq i \leq m} \{ {Bw}_{i} \times ( 1 - {R}_{i}^{usage} ) \}} - \\ {γ}_{St} \times \frac{{Freq}_{i}^{serve}}{{max}_{1 \leq i \leq m} \{ {Freq}_{i}^{serve} \}}\end{matrix}$$
or a mathematical equivalent thereof where: G^{St}ᵢ is the goodness value for a node identified by an index, i, EstimatedStay is a measure of reliability of the i^{th} node, m is the number of nodes in the plurality of nodes, Bwᵢ is the bandwidth made available by the i^{th} node, Rᵢ^{usage} is a measure of a degree to which bandwidth made available by the i^{th} node has been exploited, F^{reqserve}ᵢ is a measure of the number of requests for segments that have been served by the i^{th} node in a recent time interval and α_{St}, β_{St}, γ_{St} are weighting factors.

10. A method according to claim 1 comprising forwarding one or more of the segments of the data item for hosting by a plurality of the nodes of the subset.

11. A method according to claim 1 wherein evaluating the suitabilities comprises receiving a list of nodes of the plurality of nodes sorted according to a measure of suitability.

12. A method according to claim 11 wherein the nodes are arranged in one or more clusters, the one or more clusters have a topology having a core node at its root, and receiving the list of nodes comprises requesting the list of nodes from the core node of a cluster and receiving the list of nodes in response to the request.

13. A method according to claim 11 comprising assigning the segments to the nodes sequentially in order of the position of the nodes in the list.

14. A method according to claim 12 wherein the nodes are organized in a plurality of the clusters, and the method comprises receiving a list from each of the core nodes, each of the lists listing a plurality of nodes associated with the cluster.

15. A method according to claim 14 wherein each of the lists comprises a list of nodes and a measure of suitability associated with each of the listed nodes.

16. A method according to claim 1 wherein the data item comprises a media file and dividing the data item into a plurality of segments comprises dividing the media into temporally-sequential segments.

17. A method according to claim 16 wherein dividing the data item into a plurality of segments comprises dividing one or more of the temporally-sequential segments into a plurality of blocks.

18. A method according to claim 1 wherein each of the nodes comprises a data processor executing peer-to-peer software that receives any forwarded segments and stores the forwarded segments in a local data store accessible to the data processor.

19. A method according to claim 1 wherein the data item comprises a video file.

20. A method for streaming a data item on a data communication network, the data item comprising a plurality of segments, the segments hosted on a plurality of nodes on the network, the method comprising:
downloading and sequentially playing segments of the data item; wherein:
downloading the segments comprises downloading data from each of a plurality of different ones of the nodes to a receiving node; and,
for at least one of the segments, downloading the segment comprises identifying two or more of the nodes that host the segment and requesting different portions of the segment from each of the two or more of the nodes

21. A method according to claim 20 wherein the portions of the segment comprise blocks and the method comprises requesting the blocks from the plurality of nodes according to a round-robin scheme.

22. A method according to claim 20 wherein each of the segments comprises a plurality of blocks and the method comprises requesting from each of the two or more of the nodes a number of the blocks based upon a bandwidth available from the node.

23. A method according to claim 22 comprising requesting a first plurality of the blocks from one node of the two or more of the nodes that has a highest bandwidth among the two or more of the nodes.

24. A method according to claim 23 comprising, taking each of the blocks in sequence order and, for each of the blocks, requesting the block from one of the two or more of the nodes that can complete delivery of the block at the earliest time.

25. A method according to claim 20 wherein the data item comprises a media file and the method comprises buffering a number of the blocks and commencing playback of the media file after the number of the blocks have been buffered.

26. A method according to claim 25 wherein it is desired to play the media file at a bit rate Br and identifying two or more of the nodes that host the segment comprises identifying a set of the nodes that host the segment and have an available aggregate bandwidth at least equal to Br.

27. A method according to claim 20 comprising making a determination that a node is not providing a requested portion of a segment and, in response to the determination requesting the requested portion of the segment a substitute node from which the requested segment can be obtained.

28. A method according to claim 20 wherein the data item comprises a media file, the method is performed at the receiving node at which the media file is to be played, and the method comprises, at the receiving node, generating a schedule for downloading blocks of the data item and sending the schedule to the two or more of the nodes.

29. A method according to claim 20 wherein identifying two or more of the nodes that host the segment comprises, selecting an agent node based upon a sequence position of the segment in the data item and querying the selected agent node to identify nodes that host the segment.

30. A method according to claim 20 comprising, after requesting one of the portions from one of the two or more of the nodes:
determining that the one of the two or more of the nodes has not provided the requested portion;
identifying another node that hosts the at least one of the segments; and,
requesting the requested portion from the another node.

31. A method according to claim 20 comprising, upon receiving data from the data item, forwarding the data to another device by a data communication channel including a wireless link.

32. A method according to claim 31 comprising initiating downloading the data item in response to a request from the another device.

33. A method for locating a desired data item in a distributed storage system comprising a plurality of nodes interconnected by a data communication network, the method comprising:
determining a category for the desired data item from among a plurality of categories;
selecting an agent node based upon the category for the desired data item;
querying the selected agent node for the desired data item using at least one keyword associated with the desired data item; and,
at a requesting node, receiving from the selected agent node an identification of one or more nodes of the system that host the desired data item.

34. A method according to claim 33 wherein the nodes of the system are arranged in one or more clusters, there is an agent node for the category in each of the clusters, and the method comprises querying the agent nodes of a plurality of the clusters for the desired data item.

35. A method according to claim 34 wherein the selected agent node and the requesting node belong to the same one of the clusters and querying the agent nodes of other ones of the plurality of clusters is performed by the selected agent node.

36. A method according to claim 34 comprising, at the receiving node, waiting for a predetermined time period to receive responses to the queries from the selected agent node and from the agent nodes of other clusters and, after the predetermined time period, selecting one or more nodes identified by the responses to deliver the desired data item.

37. A method according to claim 33 comprising maintaining a category table at the requesting node, the category table associating each of the plurality of categories with a corresponding agent node.

38. A method according to claim 37 wherein the category table comprises a timestamp indicating when each of the plurality of categories became associated with the corresponding agent node.

39. A method according to claim 38 comprising, at one node, receiving a category table from another node and updating the category table at the one node based upon the received category table.

40. A method according to claim 33 wherein the desired data item comprises a media file and the categories comprise categories for a plurality of different media genres.

41. A system for storage and delivery of data items, the system comprising:
a plurality of nodes, each of the plurality of nodes comprising a data processor, a data store accessible to the data processor, and stored computer instructions executable by the data processor; and,
a data communication network interconnecting the plurality of nodes; wherein, for at least some of the nodes:
the computer instructions, when executed, control the data processor to retrieve data from a selected data item by downloading a plurality of segments of the data item and sequentially playing the segments of the data item; wherein:
at least one of the segments comprises a plurality of blocks and downloading the segment comprises identifying two or more other nodes that host the segment and requesting different blocks of the segment from each of the two or more of the nodes.

42. A system according to claim 41 wherein the data items comprise media files and the computer instructions comprise instructions that cause a playback system to commence playing the data item at the node before all segments of the data item have been received.

43. A system according to claim 41 wherein the computer instructions control the data processor to determine a bandwidth available from each of the other nodes that host the segment and create a schedule for retrieving the blocks of the segment from two or more of the other nodes that host the segment based at least in part upon the available bandwidths for the other nodes that host the segment.

44. A system according to claim 43 wherein the computer instructions control the data processor to take each of the blocks in sequence order and, for each of the blocks, request the block from one of the other nodes that host the segment and can complete delivery of the block at the earliest time.

45. A system according to claim 43 wherein the computer instructions control the data processor to cache downloaded segments in the data store and to deliver those cached segments to other nodes in response to requests from the other nodes for the cached segments.

46. A system according to claim 43 wherein:
the nodes are arranged in a plurality of clusters,
the data items are each associated with a category,
within each cluster, each category is associated with one agent node that comprises a record of the location in the cluster of the data items associated with the category, and,
each node comprises a record of a plurality of agent nodes for the cluster and their associated categories.

47. A system according to claim 43 wherein at least some of the nodes comprise set top boxes in a cable television system.

48. A system for storage and streaming delivery of data items, the system comprising:
a plurality of nodes interconnected by a data communication network, at least some of the nodes comprising:
a data store;
means for identifying two or more other nodes storing a segment of a desired data item, the segment comprising a plurality of blocks;
means for requesting a block of the segment from each of the two or more of the nodes;
means for receiving the blocks from the other nodes; and,
means for playing the blocks in sequence.

49. A system according to claim 47 wherein the at least some nodes comprise means for scheduling delivery of the blocks from the other nodes based upon available bandwidths of the other nodes.

50. A system according to claim 48 wherein at least some of the nodes comprise set top boxes in a cable television system.
